(19) United States
(12) Patent Application Publication
(10) Pub. No.: US 2016/0114767 A1
(43) Pub. Date: Apr. 28, 2016

(54) LIQUID DISPENSING APPARATUS

(71) Applicant: UMM AL-QURA UNIVERSITY, Makkah (SA)

(72) Inventor: Saleh Abdullah Saleh AL SALAMEH, Al Rass (SA)

(73) Assignee: UMM AL-QURA UNIVERSITY, Makkah (SA)

(21) Appl. No.: 14/397,691

(22) PCT Filed: Oct. 22, 2014
(86) PCT No.: PCT/IB14/02202

§ 371 Date: Oct. 29, 2014

(51) Int. Cl. B60S 1/52; B60S 1/48; B05B 12/08

(52) U.S. Cl. CPC B60S 1/524; B05B 12/081; B60S 1/481

(57) ABSTRACT

A liquid dispensing system includes a first container configured to house a first liquid, a plurality of nozzles, and a flow path connecting the first container to the plurality of nozzles. A second container configured to house a second liquid and having an electric valve mechanism which is disposed in the flow path downstream from the first container and upstream from the plurality of nozzles. A pump is in fluid communication with the first container and the plurality of nozzles and the pump is configured to force the first liquid and the second liquid through the flow path to be emitted by the plurality of spray nozzles. The liquid dispensing system further includes a controller that controls the electric valve mechanism and opens it to an open position to disperse the second liquid from the second container into the flow path upon an receiving a signal from a user.

### BACKGROUND

Windshields on motor vehicles are known to have windshield wipers, which are used to remove rain, debris, and the like from the windshield that might obstruct the driver's visibility. A windshield wiper generally includes an arm that pivots about a fixed point with a long rubber blade attached to the other end. The blade generally oscillates back and forth over the glass, pushing water and debris from the windshield.

Motor vehicles can also contain systems for applying washer fluid onto a windshield to assist the windshield wiper blades to remove any dirt, debris, bugs, and so forth. Sometimes, water is insufficient to remove all of the debris on the windshield that could possibly obstruct a driver's visibility.

### SUMMARY

In selected embodiments, a liquid dispensing system includes a first container configured to house a first liquid, a plurality of nozzles, and a flow path connecting the first container to the plurality of nozzles. A second container configured to house a second liquid and having an electric valve mechanism which is disposed in the flow path downstream from the first container and upstream from the plurality of nozzles. A pump is in fluid communication with the first container and the plurality of nozzles and the pump is configured to force the first liquid and the second liquid through the flow path to be emitted by the plurality of spray nozzles. The liquid dispensing system further includes a controller that controls the electric valve mechanism and opens it to an open position to disperse the second liquid from the second container into the flow path upon an receiving a signal from a user.

The foregoing paragraphs have been provided by way of general introduction, and are not intended to limit the scope of the following claims. The details of one or more implementations will be best understood by reference to the following detailed description taken in conjunction with the accompanying drawings. Other features, objects, and advantages will be apparent from the description and drawings, and from the claims.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates an exemplary embodiment of the electric valve mechanism for dispersing a first and second liquid on a windshield according to one example;

FIG. 2 illustrates an exemplary embodiment of the electric valve mechanism in an open position according to one example;

FIG. 3 illustrates an exemplary embodiment of the electric valve mechanism in a closed position according to one example;

FIG. 4 illustrates an exemplary embodiment of dispersing the first and second liquid on the windshield according to one example; and

FIG. 5 illustrates a hardware device configuration of the controller according to one example.

### DETAILED DESCRIPTION

Referring now to the drawings, wherein like reference numerals designate identical or corresponding parts throughout the several views.

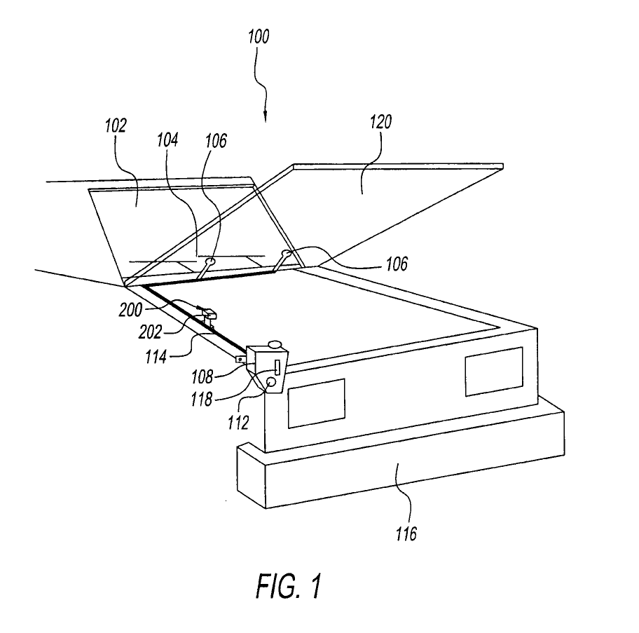

Referring to FIG. 1, a windshield cleaning system 100 for cleaning the windshield 102 of a vehicle 116, according to an exemplary embodiment of the present disclosure is illustrated. The windshield cleaning system 100 includes a windshield 102 and at least one windshield wiper 104. The windshield cleaning system 100 disperses a liquid on the windshield 102 by way of a plurality of spray nozzles or jets 106. A first container 108, which is located under a hood 120 of the vehicle 116, holds a first liquid 110 and includes a pump 112. The first liquid is pumped through a flow path 114 by the pump 112 to the plurality of spray nozzles 106 and dispersed on the windshield 102. In selected embodiments, the first fluid 110 can be water, windshield wiper fluid, deicer liquid, bug-removal liquid, a combination thereof, or the like. After the first liquid 110 is sprayed on the windshield 102, the windshield wipers 104 may be activated to squeegee the first liquid 110 off the windshield 102 and clean the windshield 102 at the same time.

In one embodiment, the first liquid may be water, or another windshield wiper fluid that does not contain detergent. However, the application of the first liquid onto the windshield 102, and the activation of the windshield wipers 104 may not be enough to clean the windshield. For example, the windshield may have an oily residue.

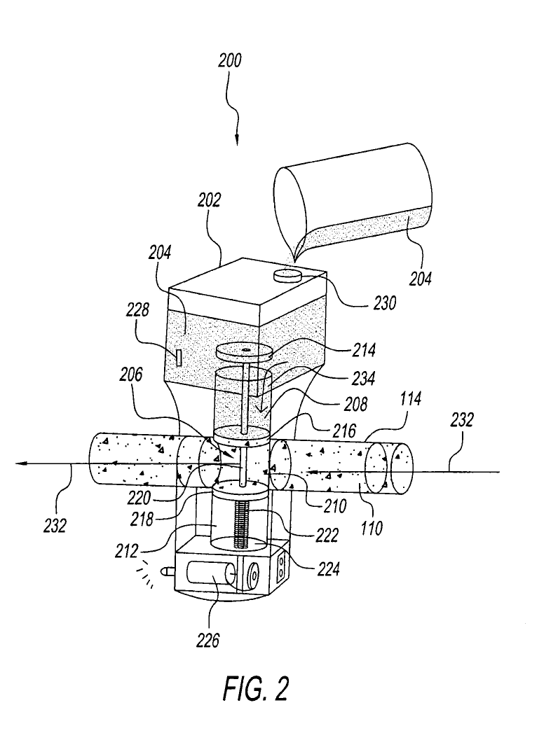

In one embodiment, the windshield cleaning system further includes an electric valve mechanism 200 that is controlled by a controller, as illustrated in FIG. 2. The electric valve mechanism 200 is located downstream from the first container 108, and upstream from the plurality of nozzles 106 and within the flow path 114. The first liquid 110 flows in the direction of the arrow 232. The electric valve mechanism 200 can be installed in the vehicle 116 when the vehicle 116 is assembled, or the electric valve mechanism 200 can be installed aftermarket. By adding the electric valve mechanism 200 directly into the flow path 114 there is a benefit of being able to have two liquids mix together without the use of a mixing chamber or a second flow path.

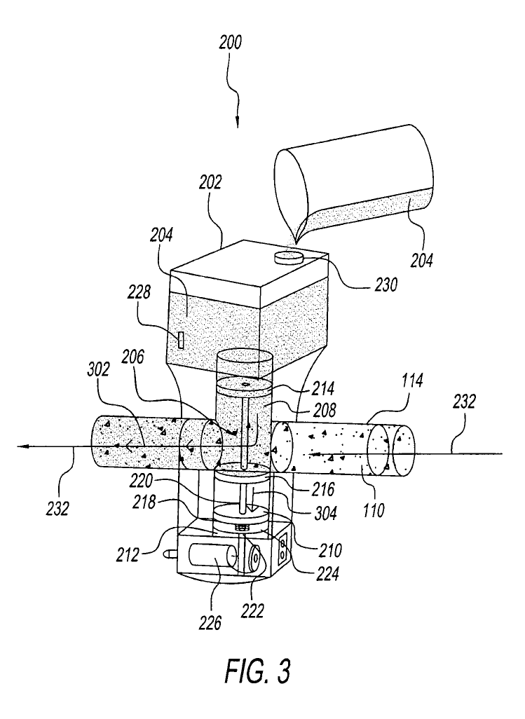

The electric valve mechanism 200 contains a second container 202 that contains a second liquid 204 and a valve 206 that connects the second container 202 to the flow path 114. FIG. 2 illustrates the electric valve mechanism 200 when the valve is closed. FIG. 3 illustrates the electric valve mechanism 200 when the valve is open. When the valve 206 is open, the second liquid 204 may be dispersed into the flow path 114 to mix with the first liquid 110 as the first liquid is being pumped to the plurality of nozzles 106. As the valve 206 opens, gravity and the pump 112 that pumps the first liquid, help mix the two liquids together. The first liquid 110 and the second liquid 204 flow simultaneously in the direction of the arrow 232 shown in FIGS. 2 and 3 to the plurality of nozzles. The second liquid 204 may only be dispersed when the pump 112 of the first container 108 is pumping the first liquid 110 and valve 206 is open to the flow path 114.

According to one embodiment, the second liquid 204 may be a detergent that mixes with the first liquid 110 when the valve 206 is open. The mixture would create a cleaning solution for cleaning the windshield 102 of the vehicle 116.

In an exemplary embodiment, the second container has an opening 230 on the top of the second container 202. The second liquid 204 can be poured into the opening 230 to replenish the second liquid 204 as needed.

The valve 206 connects the second liquid 204 to the flow path 114. The valve includes three distinct chambers: a first or top chamber 208, a second or middle chamber 210, and a third of bottom chamber 212. Each chamber has a seal cap that separates the three chambers from each other. A first seal cap 214 is located above the top of the first chamber 208, a second seal cap 216 is located between the first 208 and second chamber 210 and a third seal cap 218 is located between the second 210 and the third chamber 212. The seal caps are connected to together by a valve bar 220.

Referring to FIG. 2, when the valve 206 is closed according to one possible embodiment, the first chamber is open to the second liquid 204, which allows the second liquid 204 to enter the first chamber 208, as shown by arrow 234. When the valve 206 is closed, the second liquid 204 is unable to access the flow path 114.

The second chamber 210 coincides with the flow path 114. Therefore, when the valve 206 is closed, the first liquid 110 is able to be pumped from the first container 108 to the plurality of nozzles 106 through by way of the flow path 114 and passing through the second chamber of the valve 206, as shown by the arrow 232. The second seal cap 216 seals the first chamber 208 from the flow path 114, and the third seal cap 218 seals the third chamber 212 from the flow path 114. The height of the second chamber 210, or the distance between the second seal cap 216 and the third seal cap 218 may be the same as the diameter of the flow path 114. Therefore, when the valve 206 is closed, the second liquid cannot enter the flow path 114, nor can the first liquid 110 enter the third chamber 212.

The third chamber 212 includes a spring 222 that is attached to the third seal cap 218 and the bottom 224 of the third chamber 212, and is wrapped around the valve bar 220.

The valve 206 further includes a motor 226. The motor 226 opens and closes the valve 206. When the motor 226 is activated, the motor 226 pulls the valve bar 220 and compresses the spring 222 in the third chamber 212. Movement of the valve bar 220 can be done through the use of a rack and pinion, pulley or the like. As the valve bar 220 is pulled down, the seal caps are simultaneously moved. This opens the first chamber 208 into the flow path 114, which allows the second liquid 204 to disperse into the flow path 114, as illustrated in FIG. 3 by arrow 302. After the second liquid 204 is allowed to disperse into the flow path 114, the motor 226 is turned off, and the compressed spring 222 recoils and the seals caps are move back into the closed position which seals the valve 206. Alternatively, a worm gear could be used in place of the spring 222.

According to an exemplary embodiment, when the valve 206 is open, the first seal cap 214 seals the top of the first chamber 208 shortly after the first chamber 208 is opened to the flow path 114. In this manner, a predetermined amount of second liquid 204 enters the flow path 114. After the first seal cap 214 seals the top of the first chamber 208, the second liquid 204 inside the second container 202 cannot flow into the flow path 114.

According to an exemplary embodiment, the position of the first seal cap 214 on the valve bar 220 can be adjusted to vary the amount of the second liquid 204 that is allowed to enter the flow path 114. For example, the distance between the first seal cap 214 and the second seal cap 216 can be altered by adjusting the first seal cap 214 closer to or further away from the second seal cap 216. By adjusting the first seal cap 214 toward the second seal cap 214, a smaller amount of the second liquid 204 will be dispersed. By adjusting the first seal cap 214 further away from the second seal cap 216, a larger amount of the second liquid 204 will be dispersed. In this manner, the predetermined amount of the second liquid 204 could be varied. This allows the user to have a stronger concentration of the second liquid 204 for stronger cleaning properties. This also allows the user to conserve the second liquid 204 by only using small amounts of the second liquid 204 to be introduced into the flow path 114.

The first seal cap 214 could be adjusted manually to vary the amount of the predetermined amount of the second liquid 204.

Alternatively in another exemplary embodiment, the first chamber 208 of the valve does not include the first seal cap 214. When a signal from the user is sent to the controller, the controller activates the motor 226 and opens the valve 206. The valve remains open until the signal is terminated. When the signal is terminated, the motor 226 is deactivated, and the spring 222 recoils and closes the valve 206. Therefore, the valve 206 will remain open for a variable amount of time, depending on how long the user sends the signal. The user will be able to determine how long to open the valve and allow a variable amount of the second liquid 204 to be added to the first liquid 110. For example, if the windshield was especially dirty or oily, the user could add more detergent than if the windshield was relatively clean. By allowing the user to vary the amount of detergent used, the user may conserve detergent.

The controller activates the motor 226 to compress the spring 222 and open the valve 206. To operate the electric valve mechanism 200, a user needs to send a signal to the controller.

The signal sent to the controller originates with the user. The signal could originate from a number of different locations. For example, in one exemplary embodiment, the user transmits the signal wirelessly via a remote control. In another exemplary embodiment, the signal could originate from a driver's console within the vehicle 116. For example, a button on a steering wheel, etc.

Additionally, in selected embodiments, the first container 108 and the second container 202 may both include sensors for detecting the amount of respective liquid within the containers. For example, the first container 108 could have a first sensor 118 for detecting the level of the first liquid 110 in the first container 108 and the second container 202 could have a second sensor 228 for detecting the level of the second liquid 204 in the second container 202.

The sensors 118 and 228 may communicate the level of the respective liquid in each container to the controller as would be understood by one of ordinary skill in the art. If the level of either liquid is below a predetermined level, the controller transmits a signal, or warning, indicating that the liquid is low. The warning could be audio, visual, tactile or a combination.

In one embodiment, when the second sensor 228 senses that the second liquid 204 is below a predetermined threshold within the second container 202, the controller only allows a predetermined amount of the second liquid to disperse into the flow path 114. Thus, the controller knows a setting of the distance between the first seal cap 214 and the second seal cap 216 and can lower the amount of that is dispersed accordingly and inform the user of how many uses are left. This way, a user cannot accidently use too much of the second liquid 204 on the variable setting. Further, if the second sensor 228 senses that the second liquid is below a second predetermined threshold, the controller could prevent the valve 206 from opening and dispersing the second liquid 204.

The first liquid 110 and second liquid 204 can be dispersed on the windshield 102 in a variety of ways. FIG. 1 illustrates an exemplary embodiment where the plurality of nozzles 106 can be located at the based on the windshield 102. The first liquid 110 and second liquid 204 can be dispersed from the nozzles 106 at the base of the windshield 102 onto the windshield 102. The force needed to disperse the liquids can come from the pump 112 in the first container 108.

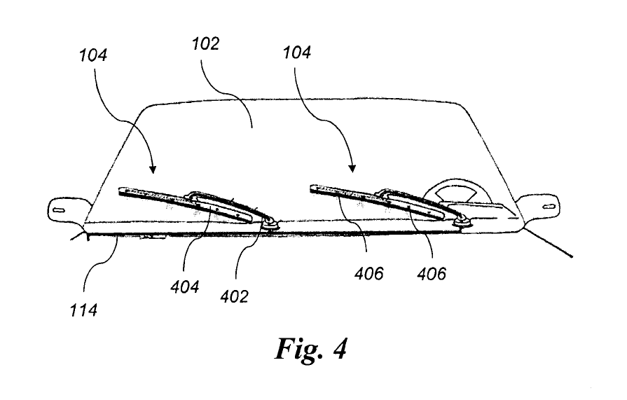

FIG. 4 illustrates another exemplary embodiment dispersing the first liquid 110 and the second liquid 204 on the windshield 102. The flow path 114, which transports the first liquid 110 and the second liquid 204 from their respective containers, further extends onto the windshield wipers 104. The flow path 114 can be attached to the outside of the windshield wipers 104, or the flow path can be inserted into the windshield wipers 104 themselves. The flow path 114 extends along the windshield wiper handle 402 until it reaches a junction between the windshield wiper handle 402 and the windshield wiper blade 404. At the junction, the flow path splits in both directions and extends along the entire length of the windshield wiper blade 404. The flow path 114 can have a plurality of holes 406 or valves, which extends along the entire length of the windshield wiper blade 404. The plurality of holes 404 can serve as the plurality of nozzles. In this manner, the first liquid 110 and the second liquid 204 can be applied to the windshield 102 from the windshield wipers 104.

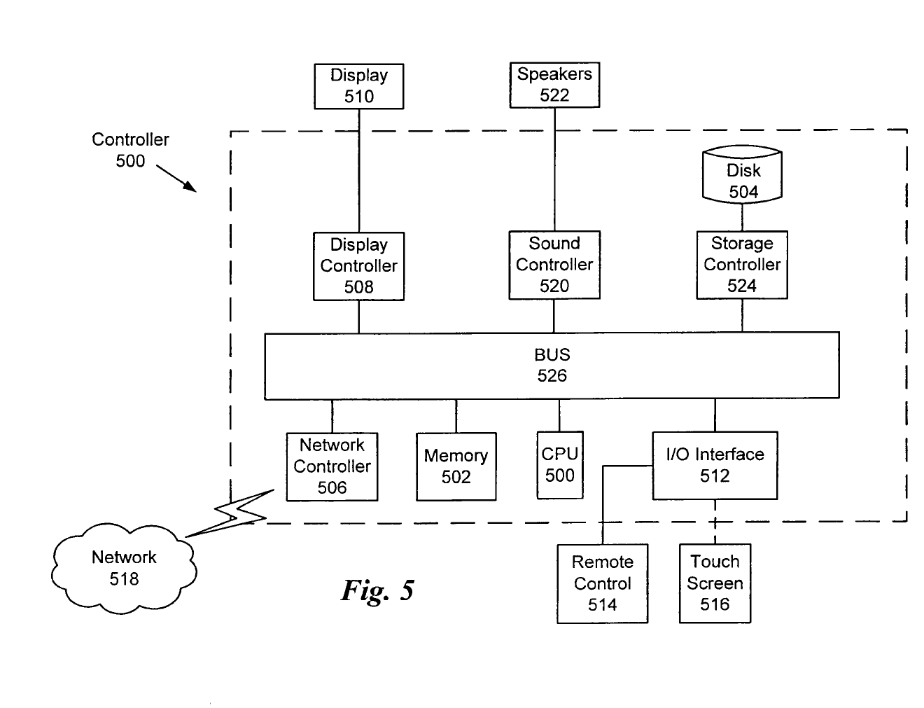

Next, a hardware description of the controller according to exemplary embodiments is described with reference to FIG. 5. In FIG. 5, the controller includes a CPU 500 which performs the processes described above. The process data and instructions may be stored in memory 502.

CPU 500 may be a Xenon or Core processor from Intel of America or an Opteron processor from AMD of America, or may be other processor types that would be recognized by one of ordinary skill in the art. Alternatively, the CPU 500 may be implemented on an FPGA, ASIC, PLD or using discrete logic circuits, as one of ordinary skill in the art would recognize. Further, CPU 500 may be implemented as multiple processors cooperatively working in parallel to perform the instructions of the inventive processes described above.

The controller in FIG. 5 also includes a network controller 506, such as an Intel Ethernet PRO network interface card from Intel Corporation of America, for interfacing with network 518. As can be appreciated, the network 518 can be a public network, such as the Internet, or a private network such as an LAN or WAN network, or any combination thereof and can also include PSTN or ISDN sub-networks. The network 518 can also be wired, such as an Ethernet network, or can be wireless such as a cellular network including EDGE, 3G and 4G wireless cellular systems. The wireless network can also be WiFi, Bluetooth, or any other wireless form of communication that is known.

The controller further includes a display controller 508, such as a NVIDIA GeForce GTX or Quadro graphics adaptor from NVIDIA Corporation of America for interfacing with display 510, such as a Hewlett Packard HPL2445w LCD monitor. A general purpose I/O interface 512 interfaces with a remote control 514 as well as a touch screen panel 516 on or separate from display 510.

A sound controller 520 is also provided in the controller, such as Sound Blaster X-Fi Titanium from Creative, to interface with speakers/microphone 522 thereby providing sounds and/or music.

The general purpose storage controller 524 connects the storage medium disk 404 with communication bus 526, which may be an ISA, EISA, VESA, PCI, or similar, for interconnecting all of the components of the controller. A description of the general features and functionality of the display 510, remote control 514, as well as the display controller 508, storage controller 524, network controller 506, sound controller 520, and general purpose I/O interface 512 is omitted herein for brevity as these features are known.

Obviously, numerous modifications and variations of the present invention are possible in light of the above teachings. It is therefore to be understood that within the scope of the appended claims, the invention may be practiced otherwise than as specifically described herein.

The above disclosure also encompasses the embodiments listed below.

(1) A liquid dispensing system including a first container configured to house a first liquid, a plurality of nozzles, a flow path connecting the first container to the plurality of nozzles, a second container configured to house a second liquid and having an electric valve mechanism disposed in the flow path downstream from the first container and upstream from the plurality of nozzles, a pump in fluid communication with the first container and the plurality of nozzles, the pump configured to force the first liquid and the second liquid through the flow path to be emitted by the plurality of spray nozzles, and a controller that controls the electric valve mechanism to an open position to disperse the second liquid from the second container into the flow path upon an receiving a signal.

(2) The liquid dispensing system of (1), wherein the controller controls the electric valve mechanism to the open position upon receiving the signal and maintains the open position until the signal is terminated thereby providing a variable amount of the second liquid.

(3) The liquid dispensing system of (1) or (2), wherein the controller controls the electric valve mechanism to the open position for a predetermined duration upon receiving the signal to allow a predetermined fixed amount of the second liquid to disperse into the flow path.

(4) The liquid dispensing system of (1) to (3), wherein the electric valve mechanism further includes a valve that separates the second container from the flow path and includes a first and second seal caps connected by a valve bar and a motor, wherein the controller, in response to receiving one or more signals, activates the motor to move the valve bar to adjust the location of the seal caps with respect to the flow path to either place the valve in the open position or to place the valve in a closed position to prevent the second liquid from entering the flow path.

(5) The liquid dispensing system of (1) to (4), wherein the distance between the first seal cap and the second seal cap is greater than the diameter of the flow path.

(6) The liquid dispensing system of (1) to (5), wherein a position of the first seal cap on the valve bar can be adjusted relative to the second seal cap.

(7) The liquid dispensing system of (1) to (6), further comprising a sensor that detects the level of the second liquid in the second container and the controller adjust the position of the first seal cap based on the sensor.

(8) The liquid dispensing system of (1) to (7), wherein the electric valve mechanism further includes a third seal cap and a spring attached to the third seal cap and surrounding a portion of the valve bar, wherein when the controller activates the motor, the spring is compressed by the movement of the valve bar.

(9) The liquid dispensing system of (1) to (8), further including a first sensor to detect a first liquid level in the first container.

(10) The liquid dispensing system of (1) to (9), further including a second sensor to detect a second liquid level in the second container.

(11) The liquid dispensing system of (1) to (10), wherein when the second sensor indicates that the second liquid level falls below a predetermined level, the controller causes the electric valve mechanism to disperse a predetermined fixed amount of the second liquid into the flow path.

(12) The liquid dispensing system of (1) to (11), wherein when the second sensor indicates that the second liquid level falls below a predetermined level, the controllers prohibits the electric valve mechanism from dispersing the second liquid into the flow path.

(13) The liquid dispensing system of (1) to (12), wherein when the second sensor indicates that the second liquid level falls below a predetermined level, the controller transmits a signal indicating a low level of the second liquid.

(14) The liquid dispensing system of (1) to (13), wherein the signal is transmitted wirelessly.

(15) The liquid dispensing system of (1) to (14), wherein the first liquid is windshield wiper fluid.

(16) The liquid dispensing system of (1) to (15), wherein the first liquid is different from the second liquid.

(17) The liquid dispensing system of (1) to (16), wherein the second liquid is detergent.

(18) The liquid dispensing system of (1) to (17), wherein the pump pumps the second liquid through the flow path simultaneously with the first liquid to the plurality of nozzles.

(19) The liquid dispensing system of (1) to (18), wherein the second liquid from the second container flows directly into the flow path.

(20) The liquid dispensing system of (1) to (19), wherein the plurality of nozzles are located along the length of a windshield wiper blade.

What is claimed is:

1. A liquid dispensing system comprising:
a first container configured to house a first liquid;
a plurality of nozzles;
a flow path connecting the first container to the plurality of nozzles;
a second container configured to house a second liquid and having an electric valve mechanism disposed in the flow path downstream from the first container and upstream from the plurality of nozzles;
a pump in fluid communication with the first container and the plurality of nozzles, the pump configured to force the first liquid and the second liquid through the flow path to be emitted by the plurality of spray nozzles; and
a controller that controls the electric valve mechanism to an open position to disperse the second liquid from the second container into the flow path upon an receiving a signal.

2. The liquid dispensing system of claim 1, wherein
the controller controls the electric valve mechanism to the open position upon receiving the signal and maintains the open position until the signal is terminated thereby providing a variable amount of the second liquid.

3. The liquid dispensing system of claim 1, wherein
the controller controls the electric valve mechanism to the open position for a predetermined duration upon receiving the signal to allow a predetermined fixed amount of the second liquid to disperse into the flow path.

4. The liquid dispensing system of claim 1, wherein the electric valve mechanism further includes
a valve that separates the second container from the flow path and includes a first and second seal caps connected by a valve bar; and
a motor,
wherein the controller, in response to receiving one or more signals, activates the motor to move the valve bar to adjust the location of the seal caps with respect to the flow path to either place the valve in the open position or to place the valve in a closed position to prevent the second liquid from entering the flow path.

5. The liquid dispensing system of claim 4, wherein the distance between the first seal cap and the second seal cap is greater than the diameter of the flow path.

6. The liquid dispensing system of claim 4, wherein a position of the first seal cap on the valve bar can be adjusted relative to the second seal cap.

7. The liquid dispensing system of claim 6, further comprising a sensor that detects the level of the second liquid in the second container and the controller adjust the position of the first seal cap based on the sensor.

8. The liquid dispensing system of claim 4, wherein the electric valve mechanism further includes a third seal cap and a spring attached to the third seal cap and surrounding a portion of the valve bar, wherein when the controller activates the motor, the spring is compressed by the movement of the valve bar.

9. The liquid dispensing system of claim 1, further comprising:
a first sensor to detect a first liquid level in the first container.

10. The liquid dispensing system of claim 1, further comprising:
a second sensor to detect a second liquid level in the second container.

11. The liquid dispensing system of claim 10, wherein when the second sensor indicates that the second liquid level falls below a predetermined level, the controller causes the electric valve mechanism to disperse a predetermined fixed amount of the second liquid into the flow path.

12. The liquid dispensing system of claim 10, wherein when the second sensor indicates that the second liquid level falls below a predetermined level, the controllers prohibits the electric valve mechanism from dispersing the second liquid into the flow path.

13. The liquid dispensing system of claim 10, wherein when the second sensor indicates that the second liquid level falls below a predetermined level, the controller transmits a signal indicating a low level of the second liquid.

14. The liquid dispensing system of claim 1, wherein the signal is transmitted wirelessly.

15. The liquid dispensing system of claim 1, wherein the first liquid is windshield wiper fluid.

16. The liquid dispensing system of claim 1, wherein the first liquid is different from the second liquid.

17. The liquid dispensing system of claim 1, wherein the second liquid is detergent.

18. The liquid dispensing system of claim 1, wherein
the pump pumps the second liquid through the flow path simultaneously with the first liquid to the plurality of nozzles.

19. The liquid dispensing system of claim 1, wherein
the second liquid from the second container flows directly into the flow path.

20. The liquid dispensing system of claim 1, wherein
the plurality of nozzles are located along the length of a windshield wiper blade.
